(19) United States
(12) Patent Application Publication
(10) Pub. No.: US 2026/0252448 A1
(43) Pub. Date: Aug. 27, 2026

(54) METHODS AND SYSTEMS TO REPAIR CONSTRUCTED INFORMATION

(71) Applicant: Quanta Computer Inc., Taoyuan City (TW)

(72) Inventors: Chun-Ping HUANG, Taoyuan City (TW); Chin-Huai HSU, Taoyuan City (TW); Pei-Chun HSIEH, Taoyuan City (TW)

(21) Appl. No.: 19/064,417

(22) Filed: Feb. 26, 2025

(51) Int. Cl. G06F 11/14

(52) U.S. Cl. CPC G06F 11/1417

(57) ABSTRACT

Systems, methods, and apparatuses for repairing information in a computing system are provided. The system may include one or more data processors and a non-transitory computer-readable storage medium containing instructions which, when executed on the one or more data processors, cause the one or more data processors to perform operations. The operations may include checking if an external device operably coupled to the computing system has generated a flag indicating an issue. In response to determining that the flag has been generated, the system may generate, by the one or more data processors, one or more handlers based on the flag. Based on these flags, the system can trigger one or more handlers during a runtime of the computing system and repair information associated with the external device that caused generation of the flag.

### FIELD OF THE INVENTION

The present invention relates generally to methods and systems for repairing constructed information through runtime updates, and more specifically, to gathering and repairing incomplete UEFI-constructed information during runtime.

### BACKGROUND OF THE INVENTION

Computer systems rely on various boot systems, such as a Unified Extensible Firmware Interface (UEFI) and Basic Input/Output System (BIOS) to collect system information during Power-On Self-Test (POST) during a boot process. The collected information can then be viewed at runtime (i.e., after booting into an operation system). Some computing systems, however, may not be able to collect certain information due to connectivity issues or non-readiness of other external devices, such as a baseboard management controller (BMC) or peripherals connected by a peripheral component interface (PCI). This can result in the system not initializing complete startup data, potentially limiting its functionality. Services such as a system management BIOS (SMBIOS) and Redfish may be limited with incomplete information. In modern computer systems, since most of the services of UEFI/BIOS are no longer available at runtime, a system reset is required to perform POST again to attempt an information re-collection, resulting in significant system service downtime.

These issues can also arise when installing hot-pluggable equipment into computing systems. Hot-plug equipment such as PCI cards, solid-state drives (SSDs), and external components can be connected to a computing system during runtime. As information associated with the hot-plug devices was not initialized during the boot process, the computing system may not have complete information. This can cause limited functionality or non-readiness of the hot-plug devices.

To avoid having to reset the computing system, and to ensure the reliability and readiness of computing systems during, there is a need for methods and systems to repair information collected during startup of computing systems.

### SUMMARY OF THE INVENTION

The term embodiment and like terms, e.g., implementation, configuration, aspect, example, and option, are intended to refer broadly to all the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a computing system for repairing information in a computing system is provided. The computing system may include one or more data processors and a non-transitory computer-readable storage medium containing instructions which, when executed on the one or more data processors, cause the one or more data processors to perform operations. The operations may include checking if an external device operably coupled to the computing system has generated a flag indicating an issue. In response to determining that the flag has been generated, the system may generate, by the one or more data processors, one or more handlers based on the flag. Based on these flags, the system can trigger one or more handlers during a runtime of the computing system and repair information associated with the external device that caused generation of the flag.

According to one aspect of the present disclosure, the operations may further include checking, by the one or more data processors, if the information associated with the external devices is complete to meet a first threshold.

According to a configuration of the above implementation, the operations may further include determining that the information is incomplete if missing at least a portion of the information. In response to that determination, the system may continue the operation of the information with at least a portion of the information being missing.

According to another configuration of the above implementation, the operations may further include removing the flag associated with the external device in response to the information meeting the first threshold.

In a further aspect of the above implementation, the computing system may create a hot-plug handler configured to collect information about one or more hot-plug devices configured to be operably coupled to the computing system. During the boot process, the computing system can record information associated with memory locations of the external devices operably coupled to the system. During runtime of the computing system, it can detect if a hot-plug device has been operably coupled to the computing system. The hot-plug handlers can then be triggered by the computing system to repair the information associated with the hot-plug device.

In yet a further aspect of the above implementation, the one or more handlers can be triggered by an operating system application of the computing system.

According to another aspect of the present disclosure, the one or more handlers can be triggered by a BMC of the computing system.

According to a configuration of the above implementation, the operations may further include identifying functions of the computing system that are associated with missing information in response to the flag. Then, the computing system can generate one or more special handlers for the identified functions.

According to another configuration of the above implementation, the operations can further comprise triggering the special handlers in response to the execution of a function associated with missing information. The special handlers can then identify if the missing information has been repaired and execute the identified functions.

According to a further aspect of the present disclosure, a computer-implemented method is provided. The method may include checking if an external device operably coupled to the computing system has generated a flag indicating an issue. In response to determining that the flag has been generated, the computing system can generate one or more handlers based on the flag. The computing system can trigger the one or more handlers during a runtime of the computing system. These handlers can repair the information associated with the external device that caused generation of the flag during the runtime.

In a further aspect of the above implementation, the method may include checking, by the one or more data processors, if the information associated with the external devices is complete to meet a first threshold.

According to another configuration of the above implementation, the method may include determining that the information is incomplete if missing at least a portion of the information. Based on this determination, the computing system may continue operation with at least a portion of the information being missing.

According to another configuration of the above implementation, the method may further include removing the flag associated with the external device in response to the information meeting the first threshold.

In yet a further aspect of the above implementation, the method may include creating a hot-plug handler configured to collect information about one or more hot-plug devices configured to be operably coupled to the computing system. The method may also include recording information associated with memory locations of the external devices operably coupled to the computing system. During runtime of the computing system, the method may include detecting that a hot-plug device has been operably coupled to the computing system. In response to this coupling, the method may include triggering the hot-plug handler to update the recorded information based on information associated with the hot-plug device.

In another aspect of the above implementation, the one or more handlers may be triggered by an operating system application of the computing system.

In yet another aspect of the above implementation, the one or more handlers may be triggered by a BMC of the computing system.

According to another configuration of the above implementation, the method may further include identifying functions of the computing system that are associated with the missing information. The method may also include generating one or more special handlers associated with the identified functions.

According to another configuration of the above implementation, the method may also include triggering the one or more special handlers in response to the execution of a function associated with missing information. The special handlers may then identify that at least a portion of the missing information has been repaired. The method may further include executing at least a portion of the identified functions based on the repaired information.

In another aspect of the above implementation, at least one of the one or more handlers can be an advanced configuration and power interface (ACPI) table configured to be accessed by the computing system.

In another aspect of the present disclosure, a computer-program product tangibly embodied in a non-transitory machine-readable storage medium is given. The computer-program product may include instructions configured to cause a data processing apparatus to perform operations. The operations may include checking if an external device operably coupled to the computing system has generated a flag indicating an issue. In response to determining that the flag has been generated, the computing system can generate one or more handlers based on the flag. The computing system can trigger the one or more handlers during a runtime of the computing system. These handlers can repair the information associated with the external device that caused generation of the flag during the runtime.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a diagram showing an example method of repairing boot information, according to certain aspects of the present disclosure.

FIG. 2 is a diagram showing a detailed view of flagging missing information, according to certain aspects of the present disclosure.

FIG. 3 is a diagram showing an example method of repairing information for hot-plug devices, according to certain aspects of the present disclosure.

### DETAILED DESCRIPTION

Systems, methods, and apparatuses for repairing information in a computing system are provided. The system may include one or more data processors and a non-transitory computer-readable storage medium containing instructions. When executed on the one or more data processors, the instructions can cause the one or more data processors to perform various operations. The system may check if at least one external device operably coupled to the system has generated a flag indicating an issue. In response to at least one flag, the system may generate, by the at least one processor, one or more handlers based on the at least one issue. During runtime of the system, it can trigger the one or more handlers and repair information associated with the at least one external device indicating at least one issue.

Various embodiments are described with reference to the attached figures, where like reference numerals are used throughout the figures to designate similar or equivalent elements. Each reference numeral identifies the figure in which the reference numeral first appears based on the first digit (for three-digit reference numerals) or the first two digits (for four-digit reference numerals) corresponding to the figure numeral of the figure. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

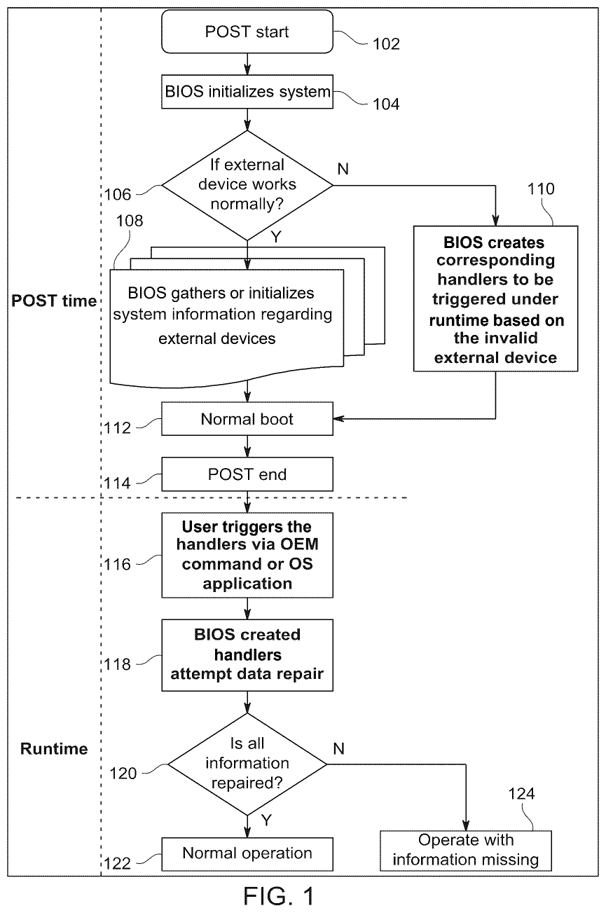

Referring to FIG. 1, an example method of repairing boot information is shown, according to certain aspects of the present disclosure. The method includes initializing a boot process of a computing system. The computing system may include one or more processors and a memory containing instructions for the one or more processors to execute. This initialization can be a Power-On Self-Test (POST) start step 102, as shown in FIG. 1. The POST start step 102 may initialize a Basic Input/Output System (BIOS). The BIOS initialization step 104 may then check if the external devices operably coupled to the computing system are working normally in step 106.

If the external devices are working normally, the BIOS can gather and initialize system information regarding the external devices. This may be done using a management tool such as a system management BIOS (SMBIOS), a server management tool such as a tool following the Redfish® specification, or another system management tool. The system information may include information such as external device location in memory of the computing system, configuration data, device specification, device requirements, or other information associated with the characteristics and functionality of the external device.

In some example embodiments of the present disclosure, the system information may be used by the BIOS and/or the computing system to determine a readiness state of the one or more external devices. This readiness verification process is depicted by step 106 of FIG. 1. Depending on a readiness state of the external devices, the system may execute various startup steps. For example, if one or more external devices are found to be working normally in step 106, the BIOS may gather or initialize information and configuration settings regarding the one or more external devices in step 108. This information can include, but is not limited to, memory locations of the devices, memory information, boot instructions, available resources, or other system information. In some embodiments of the present disclosure, the system may not require all of the requested information to be gathered or initialized to satisfy the requirements of step 106. In some example embodiments, only certain information may be required to flag the one or more external devices as working normally, or a configurable threshold can be used by the system. After step 108, the system may continue with the normal boot process step 112. The normal boot process may include various steps to initialize the system for normal operation and can conclude with a POST end step 114.

In the scenario where the system determines that at least one external device is not working normally, as defined by one of various thresholds or configurations, the BIOS may create corresponding handlers in step 110. The corresponding handlers may be a part of the BIOS or a program running on the operating system of the computing system. In some example embodiments, these programs may be configured to run during runtime of the computing system. The corresponding handlers may correspond to one or more external devices that have been flagged by the BIOS as not working normally. In some example embodiments of the present disclosure, the handlers may be system management interrupt (SMI) handlers. These SMI handlers may cause the computing system to enter a system management mode (SMM). In some other example embodiments of the present disclosure, the handlers may be advanced configuration and power interface (ACPI) tables configured to be accessed by the computing system, including ACPI tables configured by an original equipment manufacturer (OEM) of the computing system.

After POST end in step 114, the program flow of the computing system can be switched to runtime. At this point, the routine boot operations of the computing system are complete. Step 116 depicts the triggering of one or more handlers by the computing system. Through the triggering of the handlers in step 116, the BIOS configuration information of the external devices can be completed and/or updated in runtime. The handlers can be triggered via a BIOS command, such as an OEM command that the system has been configured to support, or by an application running on an operating system of the computing system.

After the handlers have been triggered, they can attempt data repair as depicted in step 118. Data repair may include various operations. For example, the handlers can attempt to contact or ping each of the flagged external devices to receive updated information. Likewise, the handlers can utilize one or more communications channels of the computing system to reestablish contact with the flagged external devices. In some example implementations, the handlers can also initialize information for the external devices according to defined startup routines. The handlers can initialize the flagged external devices and help complete the configuration information of the external devices that may have not started up correctly.

In some example embodiments of the present disclosure, the handlers may also identify and help resume incomplete routines caused by an external device failure. During POST time or runtime, an incorrectly configured or uncoupled external device may lead to certain routines or programs running on the computing system to be unable to function correctly. An example of this would be an externally coupled Secure Digital (SD) card reader. If the SD card reader is not initialized or functionally coupled to the computing system during startup, it may be unavailable to the computing system. This would mean that an SD card inserted into the card reader could not transfer any data to the computing system. When triggered, a handler configured to reestablish connection with the SD card reader during runtime could also resume the data transfer process from the SD card to the computing system, resuming processes that were unable to be completed due to the limited functionality of the external device.

In step 120 of FIG. 1, the computing system may check if the information regarding the external devices has been repaired. If the data has been repaired, the computing system will resume normal runtime operation with complete information, as depicted in step 122.

If there is information missing regarding one or more of the external devices, the computing system can still operate. In some example embodiments, such as the example implementation shown in FIG. 1, the computing system will operate with missing information, as depicted in step 124. In some other example embodiments, the computing system can continue to run at least a portion of the handlers until a threshold of information has been repaired.

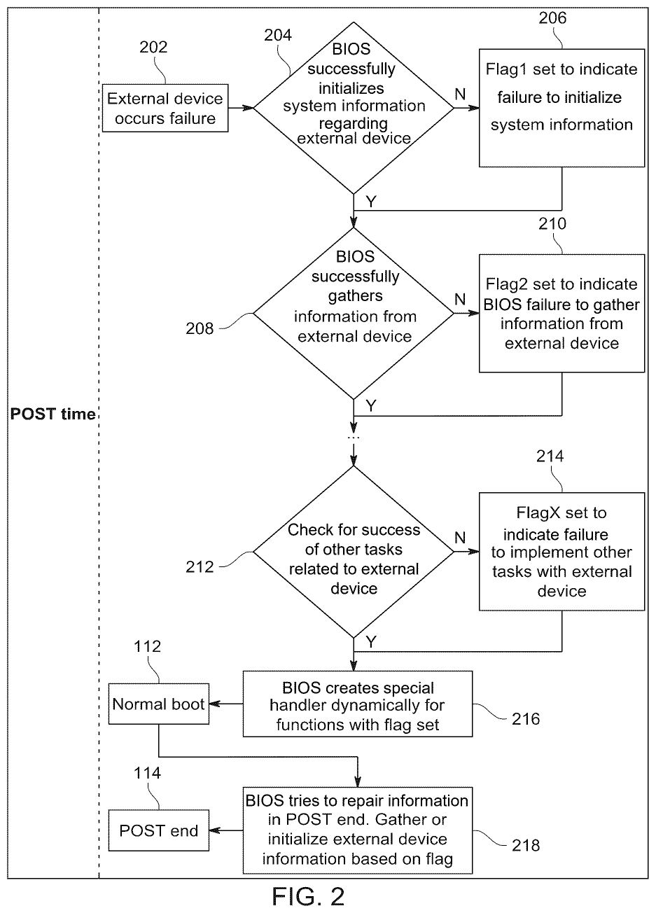

Referring to FIG. 2, a diagram showing a detailed view of a process of flagging missing information, according to certain aspects of the present disclosure, is given. FIG. 2 depicts an example embodiment of how the computing system may flag external devices that experience failures during POST time. In step 202, at least one external device coupled to the computing system has experienced a failure. In step 204, the computing system will reassess the status of the failed external device and attempt to reinitialize system information and reestablish connection with the external device. If step 204 fails, the computing system will set a flag associated with the failed external device indicating that the BIOS has not successfully initialized information associated with the device. This is depicted in step 206 of FIG. 2.

Depending on the success of the reinitialization attempts, the computing system may continually attempt to establish connection with the failed external device. This is shown in step 208 of FIG. 2. One or more flags indicating this failure to gather initial information may be generated by the computing system, as shown by step 210.

The computing system can also access what tasks and routines associated with the failed external device have succeeded, and which have failed in step 212. If the computing system identifies any failed tasks, it can generate one or more flags associated with each failed task in step 214. These flags can indicate to the computing system that the tasks need to be completed when information associated with the external device is initialized. They may also indicate what missing information associated with the external device caused the task to fail.

Step 216 of FIG. 2 depicts the computing system creating special handlers dynamically for functions and tasks with flags. These special handlers may be configured to help resume failed tasks associated with external devices or to specifically find the information necessary for the failed tasks to be completed. For example, the special handlers can be configured to find the specific memory addresses or library functions necessary for a certain failed task to be completed. In some example implementations of the present disclosure, the special handlers can be SMI handlers.

Step 218 of FIG. 2 shows how after a normal boot process step 112, the computing system can again try to repair information regarding failed external devices prior to POST end step 114. Based on the flags set during POST time, the computing system can try to reestablish communication with certain external devices before switching to runtime. This may allow external devices with a slower startup time or that have encountered boot errors to successfully be initialized by the computing system.

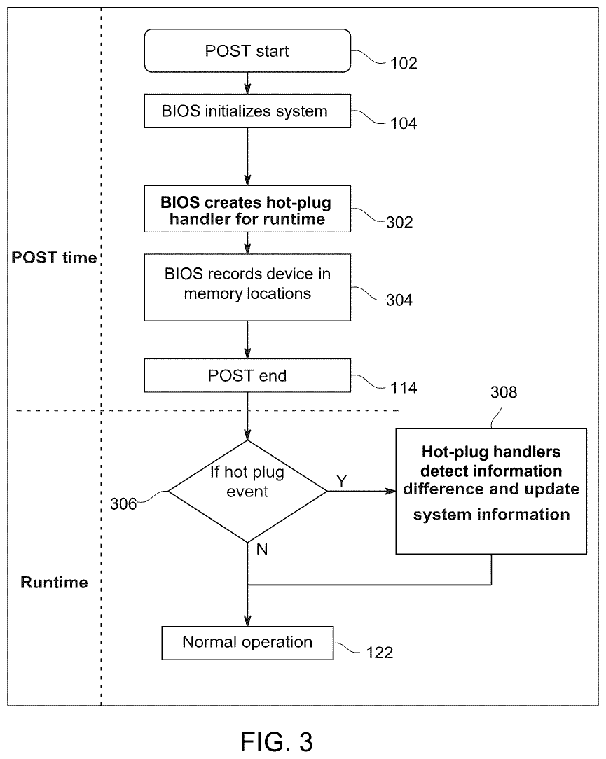

Referring to FIG. 3, diagram showing an example method of repairing information for hot-plug devices, according to certain aspects of the present disclosure, is given. A hot-plug device is a device that can be coupled to a computing system during runtime. Hot-plug devices may not have their information initialized during POST time.

Step 102 and step 104 show the POST start and BIOS initialization steps of POST time. During these steps, the computing system may attempt to initialize the information associated with all the external devices coupled to it. For hot-plug devices that may be coupled to the computing system during runtime, however, the computing system may create one or more hot-plug handlers in step 302. A hot-plug handler is a specialized handler that is meant to initialize information for hot-plug devices during runtime. It may be configured to also detect when a hot-plug device has been coupled to the system. For example, the hot-plug handlers may be configured with Peripheral Component Interface Express (PCIe) inventory data from a BMC of the computing system. This PCIe inventory data can indicate which external devices have been coupled to the computing system during POST time, and what the hot-plug coupling process for the computing system may include.

To help identify when hot-plug devices are installed into the computing system, it may record all devices coupled at startup and their respective memory locations in step 304. The computing system may store information such as NVRAM location or other locator information regarding the external devices at POST time. Other identifying information regarding the coupled external devices can also be recorded by the computing system.

During runtime, the hot-plug handler and/or the computing system can determine in step 306 if a hot-plug device has been coupled to the system based on the data initialized during POST time. If a hot-plug device has been coupled to the computing system, the computing system may trigger the hot-plug handlers in step 308. The hot-plug handlers can determine any differences between the initialized information in the BIOS and the information associated with the computing system during runtime. The hot-plug handlers can do this by comparing the memory locations and other data of devices coupled during runtime to the information recorded in step 304. Any information differences may be construed as the presence of a new hot-plug device

The hot-plug handler can also update the initialized information of the computing system to reflect the newly coupled hot-plug devices. The hot-plug handler can assess the status of the hot-plug devices, establish connections between them and the computing system, and reinitialize the BIOS data with information associated with the hot-plug devices. In some example embodiments of the present disclosure, the hot-plug handler may be configured to update the BIOS information in a format such as SMBIOS or Redfish®.

Based on the updated hot-plug BIOS information, the computing system may operate normally as in step 122.

In some example embodiments of the present disclosure, the hot-plug handlers may also generate an alert based on the presence and/or status of one or more hot-plug devices. This alert can be an operating system alert, a BIOS alert, a runtime alert, or any other type of alert to notify the computing system or the user of the presence of a hot-plug device. The alert can be displayed on a graphical user interface (GUI) displayed on a display of the computing system, or it could be used by the system to affect other processes based on the presence of the hot-plug device.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

1. A computing system comprising:
one or more data processors; and
a non-transitory computer-readable storage medium containing instructions which, when executed on the one or more data processors, cause the one or more data processors to perform operations including:
checking, by the one or more data processors during a boot process of the computing system, if an external device operably coupled to the computing system has generated a flag indicating an issue;
in response to determining that the flag has been generated:
generating, by the one or more data processors, one or more handlers based on the flag;
triggering the one or more handlers during a runtime of the computing system, the runtime being subsequent to the boot process; and
repairing during the runtime, by the one or more handlers, information associated with the external device that caused generation of the flag.

2. The computing system of claim 1, wherein the operations further include checking, by the one or more data processors, if the information associated with the external devices is complete to meet a first threshold.

3. The computing system of claim 2, wherein the operations further include:
determining that the information is incomplete if missing at least a portion of the information; and
in response to the determining, continuing the operation of the computing system with the at least a portion of the information being missing.

4. The computing system of claim 2, wherein the operations further include, in response to the information meeting the first threshold, removing, by the one or more data processors, the flag associated with the external device.

5. The computing system of claim 2, wherein the operations further include:
creating, during the boot process, and by the one or more data processors, a hot-plug handler configured to collect information about one or more hot-plug devices configured to be operably coupled to the computing system;
recording, during the boot process, and by the one or more data processors, information associated with memory locations of the external devices operably coupled to the system;
detecting, during the runtime of the computing system, and by the one or more data processors, that a hot-plug device has been operably coupled to the computing system; and
triggering, by the one or more data processors, the hot-plug handler to update the recorded information based on information associated with the hot-plug device.

6. The computing system of claim 1, wherein the one or more handlers are triggered by an operating system application of the computing system.

7. The computing system of claim 1, wherein the one or more handlers are triggered by a baseboard management controller (BMC) of the computing system.

8. The computing system of claim 1, wherein the operations further include:
in response to the flag, identifying functions of the computing system that are associated with missing information; and
generating, by the one or more data processors, one or more special handlers associated with the identified functions.

9. The computing system of claim 8, wherein the operations further comprise:
in response to the execution of a function associated with missing information, triggering, by the one or more data processors, the one or more special handlers;
identifying, by the one or more special handlers and the one or more data processors, that at least a portion of the missing information has been repaired; and
executing, by the one or more data processors, at least a portion of the identified functions based on the repaired information.

10. A computer-implemented method, comprising:
checking, by one or more data processors during a boot process of a computing system, if an external device operably coupled to the computing system has generated a flag indicating an issue;
in response to determining that the flag has been generated:
generating, by the one or more data processors, one or more handlers based on the flag;
triggering the one or more handlers during a runtime of the computing system, the runtime being subsequent to the boot process; and
repairing during the runtime, by the one or more handlers, information associated with the external device that caused generation of the flag.

11. The method of claim 10, further comprising:
checking, by the one or more data processors, if the information associated with the external devices is complete to meet a first threshold.

12. The method of claim 11, further comprising:
determining that the information is incomplete if missing at least a portion of the information; and
in response to the determining, continuing the operation of the computing system with the at least a portion of the information being missing.

13. The method of claim 11, further comprising:
in response to the information meeting the first threshold, removing, by the one or more data processors, the flag associated with the external device.

14. The method of claim 10, further comprising:
creating, during the boot process, and by the one or more data processors, a hot-plug handler configured to collect information about one or more hot-plug devices configured to be operably coupled to the computing system;
recording, during the boot process, and by the one or more data processors, information associated with memory locations of the external devices operably coupled to the computing system;
detecting, during the runtime of the computing system, and by the one or more data processors, that a hot-plug device has been operably coupled to the computing system; and
triggering, by the one or more data processors, the hot-plug handler to update the recorded information based on information associated with the hot-plug device.

15. The method of claim 10, wherein the one or more handlers are triggered by an operating system application of the computing system.

16. The method of claim 10, wherein the one or more handlers are triggered by a baseboard management controller (BMC) of the computing system.

17. The method of claim 10, further comprising:
in response to the flag, identifying functions of the computing system that are associated with missing information; and
generating, by the one or more data processors, one or more special handlers associated with the identified functions.

18. The method of claim 17, further comprising:
in response to an execution of a function associated with missing information, triggering, by the one or more data processors, the one or more special handlers;
identifying, by the one or more special handlers and the one or more data processors, that at least a portion of the missing information has been repaired; and
executing, by the one or more data processors, at least a portion of the identified functions based on the repaired information.

19. The method of claim 10, wherein at least one of the one or more handlers is an advanced configuration and power interface (ACPI) table configured to be accessed by the computing system.

20. A computer-program product tangibly embodied in a non-transitory machine-readable storage medium, including instructions configured to cause a data processing apparatus to perform operations including:
checking, by one or more data processors during a boot process of a computing system, if an external device operably coupled to the computing system has generated a flag indicating an issue;
in response to determining that the flag has been generated:
generating, by the one or more data processors, one or more handlers based on the flag;
triggering the one or more handlers during a runtime of the computing system, the runtime being subsequent to the boot process; and
repairing, during the runtime, by the one or more handlers, information associated with the external device that caused generation of the flag.
